(19) United States
(12) Patent Application Publication
(10) Pub. No.: US 2018/0002537 A1
(43) Pub. Date: Jan. 4, 2018

(54) COMPOSITIONS AND METHODS FOR PROVIDING IDENTIFYING PACKAGING

(71) Applicant: IMERYS PIGMENTS, INC., Roswell, GA (US)

(72) Inventors: Parvin GOLBAYANI, Kennesaw, GA (US); Mathew CHEESEMAN, Camborne, Cornwall (GB); Christopher PAYNTER, Atlanta, GA (US); Douglas WICKS, Johns Creek, GA (US)

(21) Appl. No.: 15/541,129

(22) PCT Filed: Dec. 30, 2015
(86) PCT No.: PCT/US15/68060

§ 371 Date: Jun. 30, 2017

Related U.S. Application Data
(60) Provisional application No. 62/099,403, filed on Jan. 2, 2015.

(51) Int. Cl. C09D 5/22; C09K 11/77; C09K 11/66; C09K 11/60; C09K 11/57; G09F 3/00; C09D 11/50

(52) U.S. Cl. CPC C09D 5/22; G09F 3/00; C09K 11/77; C09D 11/50; C09K 11/60; C09K 11/57; C09K 11/66

(57) ABSTRACT

A composition may include an aqueous base and at least one identifying additive. The at least one identifying additive may include an alkaline earth metal compound and a fluorescence activator. The at least one identifying additive may be configured such that the composition emits fluorescent light having an identifying characteristic different from a characteristic of a surface against which the identifying characteristic is viewed. A composition may include an aqueous base and at least one identifying additive including an alkaline earth metal compound and a fluorescence activator including at least one other inorganic element. The at least one identifying additive may be configured such that the composition emits fluorescent light having an identifying characteristic. A label or packaging for identifying at least one of an object and a source of the object may include a composition including at least one identifying additive associated with a surface associated with the label or packaging.

### CLAIM FOR PRIORITY

This PCT International Application claims the benefit of priority of U.S. Provisional Patent Application No. 62/099,403, filed Jan. 2, 2015, the subject matter of which is incorporated herein by reference in its entirety.

### DESCRIPTION

### Field

The present disclosure relates to compositions and related methods for providing identifying packaging, and more particularly, to compositions and related methods for providing identifying packaging including fluorescence.

Background

Labels and packaging for products are used to identify the products themselves and the source of those products. Thus, such labels and packaging help manufacturers distinguish their products from other competing products and from products from other sources. Many manufactures spend considerable resources to develop and maintain goodwill and loyalty from consumers, and such goodwill and loyalty may be tarnished if other products and sources are able to copy labels and packaging, thereby reaping the benefits of the reputation of the manufacturer. For example, name-brand manufacturers (i.e., in contrast with generic brands or counter-fit producers) rely on labels and packaging to help distinguish their products from those of other competing sources. However, it may be relatively easy to mimic or copy such labels and packaging, thereby reaping the benefits of the name-brand manufacturers good-will and reputation with customers. Thus, it may be desirable to provide labels and packaging that are not easily mimicked or copied.

Labels and packaging that include a fluorescent characteristic have been used to provide a way to verify the authenticity of the source of products. Such fluorescent characteristics may take the form of a fluorescent response when the labels or packaging are irradiated with or exposed to light having certain characteristics. Some traditional organic dyes or pigments (e.g., organic brightening agents) have been used to provide labels and packaging with fluorescent characteristics. However, these may suffer from a number of possible drawbacks. For example, traditional optical brighteners tend to be relatively expensive, rely on inclusion of toxic components (e.g., water-soluble aromatics), suffer from photobleaching upon repeated irradiation resulting in loss of effectiveness over time, are suspected of being allergens, teratogens, and/or endocrine disruptors, and may be easily produced allowing for counterfeits. Thus, although traditional optical brighteners may be desirable for providing fluorescent characteristics, it may be desirable to provide compositions that result in a reduction or elimination of the presence of traditional optical brighteners, but that still provide a fluorescent response without one or more of the above-noted drawbacks of traditional optical brighteners.

### SUMMARY

There is disclosed a composition that fluoresces when irradiated with electromagnetic energy (e.g., light). According to an aspect, the composition may be configured to emit a fluorescent response when irradiated with electromagnetic energy at a predetermined wavelength. The disclosed composition may include a base material or matrix material, such as a resin. In various aspects, the base material may comprise a fusible powder, an aqueous composition, or a solvent composition (e.g., organic solvent composition) for at least one identifying additive. The at least one identifying additive may include an alkaline earth metal compound and a fluorescence activator.

According to some aspects, the fluorescence activator may include at least one mixture, compound, element or alloy of manganese, molybdenum, copper, uranium, cesium, thorium, lead, cobalt, iron, strontium, calcium, magnesium, barium, tin, yttrium, thallium, samarium, thulium, cerium, and dysprosium. While these activators are generally used in the disclosed composition in carbonate forms, others forms are also possible, such as sulfates (SO₄), phosphates (PO₄³⁻), tungstates (WO₄) and fluorides (F⁻).

The composition may be configured for an application that takes advantage of a fluorescent response. Related products that include such a composition are also disclosed. Non-limiting examples of such products include a coating composition, a paper making composition, a sizing composition, an ink composition, a varnish composition, and a polymer composition.

There is also disclosed a label or packaging for identifying at least one object, or source of the object, and may include a surface associated with the label or packaging and a composition associated with the surface. The composition may include an aqueous base and at least one identifying additive. The at least one identifying additive may include an alkaline earth metal compound and a fluorescence activator including at least one other inorganic element. The at least one additive, which has already been described herein, may be configured such that the composition emits fluorescent light having an identifying characteristic.

There is additionally disclosed a method for providing identifying markings on paper or packaging that may include providing at least one composition in the paper or packaging, or on a surface of the paper or packaging. The composition may include at least one identifying additive including an alkaline earth metal compound and a fluorescence activator including at least one other inorganic element, The at least one identifying additive may be configured such that the composition emits fluorescent light having an identifying characteristic, for example, in the presence of ultraviolet light.

Exemplary objects and advantages will be set forth in part in the description which follows, or may be learned by practice of the exemplary embodiments. It is to be understood that both the foregoing general description and the following detailed description are exemplary and explanatory only and are not restrictive of the invention, as claimed.

### DESCRIPTION OF EXEMPLARY EMBODIMENTS

As used herein, the terms “fluorescence”, “fluoresce”, or “fluorescent response” refer to the emission of electromagnetic energy (e.g., light) by a substance that has absorbed light or other electromagnetic energy or radiation. The emitted light has a longer wavelength, and therefore lower energy, than the absorbed radiation. However, it is meant to generally encompass irradiation at one wavelength and emission of light at a different wavelength. Examples of fluorescence that can be achieved according to the present disclosure include UV to Visible (the material emits visible light after being irradiated with UV light); UV to UV (wherein the emitted and irradiated wavelengths are different); UV to Near IR; and Visible to Near IR.

As used herein the term “UV” or “ultraviolet” light refers to Near UVA (300 nm to 400 nm); UVB (280 nm to 300 nm); and UVA (100 nm to 280 nm).

As used herein, “dopant” refers to a small amount of an impurity that is an intentionally added to another material, such as an impurity intentionally added to a carbonate matrix.

As used herein, a “doped” material refers to a material in which a dopant was intentionally introduced during production. For example, a “doped carbonate” refers to a carbonate, such as CaCO₃, MgCO₃, BaCO₃, or mixtures thereof, in which a small impurity was intentionally added to change or induce fluorescent response when the carbonate was made.

Compositions and methods according to exemplary aspects of this disclosure may enable the provision of labels and packaging that reduce the likelihood of mimicking, copying, and/or counter-fitting of name-brand products. For example, the compositions according to some embodiments may be included in labels or packaging and thereby provide identifying markings that are difficult to mimic or copy. Such compositions may be used as coating compositions, papermaking compositions, sizing compositions, ink compositions, varnish compositions, and/or additives for inclusion in polymer films.

According to some embodiments, a composition may include an aqueous base and an alkaline earth metal doped with an inorganic fluorescence activator. The composition may be configured to emit a fluorescent response when irradiated, and the composition may be configured as at least one of a coating composition, a paper making composition, a sizing composition, an ink composition, a varnish composition, and a polymer composition. According to some embodiments, the inorganic fluorescence activator may include at least one mixture, compound, element or alloy of manganese, molybdenum, copper, uranium, cesium, thorium, lead, cobalt, iron, strontium, calcium, magnesium, barium, tin, yttrium, thallium, samarium, cerium, thulium, and dysprosium. According to some embodiments, the alkaline earth metal compound may have a crystal structure, and the inorganic fluorescence activator may be contained in the crystal structure. According to some embodiments, a product may include the composition.

According to some embodiments, the fluorescent response may include a predetermined fluorescent signature configured to be used as an identifying characteristic. For example, the predetermined fluorescent signature may include at least one of a brand label, a watermark, a barcode, a quick response code, a symbol, and a label configured to display observable evidence of a physical event or thermal event. According to some embodiments, the predetermined fluorescent signature may include a predetermined emission spectrum. For example, a spectrometer may be used to determine whether the fluorescent signature has a predetermined emission spectrum indicating identification or authenticity.

According to some embodiments, the fluorescent signature may be configured such that it is not visible to the naked eye, but detectable with an appropriate spectrometer. For example, the fluorescent signature may be configured such that it is not visible to the naked eye in the presence of natural light or ultraviolet light. Such embodiments of fluorescent signature may be configured to be detected by an appropriate spectrometer. Such embodiments may be difficult (or possible) to copy via electronic devices such as, for example, photocopiers, cameras, smart phones, and/or similar copying devices. According to some embodiments, the fluorescent signature may be configured such that it is visible to the naked eye, for example, in the presence of natural light and/or ultraviolet light.

According to some embodiments, the composition may be configured to emit the fluorescent response when irradiated at a predetermined wavelength. For example, the inorganic fluorescence activator may be configured such that the composition emits radiation at a different wavelength from that with which it was irradiated in the presence of ultraviolet light. For example, according to some embodiments, the composition may be configured to emit energy above, for example, about 350 nanometers in response to radiating the composition with, for example, ultraviolet light below about 450 nanometers. According to some embodiments, the composition may be configured to emit energy above, for example, about 400 nanometers in response to radiating the composition with, for example, ultraviolet light below about 400 nanometers.

According to yet another aspect. the alkaline earth metal compound may be an alkaline earth metal carbonate. For example, the alkaline earth metal carbonate may include at least one of calcium carbonate, barium carbonate, and magnesium carbonate. According to some aspects, the alkaline earth metal carbonate may include precipitated calcium carbonate (PCC), magnesium carbonate (PMC), and mixtures thereof.

According to other embodiments, the alkaline earth metal compound may comprise a natural ground calcium and/or magnesium carbonate coated with a alkaline earth metal compound doped with a fluorescence activator.

According to some aspects, the inorganic fluorescence activator may comprise up to 10 mol % of the alkaline earth metal compound, such as less than 5 mol % of the alkaline earth metal compound, or even less than 1 mol % of the alkaline earth metal compound. According to certain embodiments, these values are noted for inorganic fluorescence activators that comprise CaCO₃ or MgCO₃.

According to some embodiments, a composition may comprise a base comprising at least one identifying additive. The at least one identifying additive may include an alkaline earth metal compound and a fluorescence activator. The at least one identifying additive may be configured such that the composition emits fluorescent light having an identifying characteristic different from a characteristic of a surface against which the identifying characteristic is viewed. For example, one or more sides of packaging (e.g., a box) may have a first visual characteristic that provides a background for a second visual characteristic provided by the composition, which may take the form of a marking, such as, for example, a shape, symbol, or region within the background. For example, the at least one identifying additive may be configured such that the composition emits fluorescent light, for example, in the presence of ultraviolet light. According to some embodiments, the fluorescence activator may include at least one mixture, compound, element or alloy of manganese, molybdenum, copper, uranium, cesium, thorium, lead, cobalt, iron, strontium, calcium, magnesium, barium, tin, yttrium, thallium, samarium, cerium, thulium, and dysprosium.

According to some embodiments, the alkaline earth metal compound may have a crystal structure, and the fluorescence activator may be contained in the crystal structure.

While these activators are generally used in the disclosed composition in carbonate forms, others forms are also possible, such as sulfates (SO₄), phosphates (PO₄³⁻), tungstates (WO₄) and fluorides (F⁻).

According to some embodiments, the identifying characteristic may include at least one of a brand label, a watermark, a barcode, a quick response code, a symbol, and a label configured to display observable evidence of a physical event or thermal event. According to some embodiments, the identifying characteristic may include a predetermined emission spectrum. According to some embodiments, the at least one identifying additive may be configured such that the composition emits fluorescent light in the presence of ultraviolet light.

According to some embodiments, the identifying characteristic may be configured to facilitate identification of an object (e.g., a product) associated with the surface. According to some embodiments, the identifying characteristic may be configured to facilitate identification of a source (e.g., a manufacturer or marketer) of an object associated with the surface.

According to a further aspect, the identifying characteristic may include at least one of a predetermined wavelength and a predetermined intensity. According to some aspects, the predetermined wavelength may range from about 100 nm to about 1400 nm, such as from about 100 nm to about 750 nm, from as 100 nm to about 400 nm, from about 280 nm to about 1400 nm, 315 nm to about 1400 nm, from about 280 nm to about 750 nm.

According to one aspect, the composition may comprise mixtures of separately prepared fluorescent carbonates, such as the ones described herein, including mixtures of calcium carbonate, barium carbonate, and magnesium carbonate, to give a multi-wavelength response for a given excitation source. In this embodiment, the intensities of the different wavelength responses can be adjusted by changing the ratios of the separately prepared fluorescent carbonates.

According to still a further aspect, the at least one identifying additive may comprise up to 10 mol % of the composition, such as less than 5 mol % of the composition, or even less than 1 mol % of the composition. According to certain embodiments, these values are noted for inorganic fluorescence activators that comprise CaCO₃ or MgCO₃.

According to some embodiments, the composition may be configured as at least one of a coating composition, a paper making composition, a sizing composition, an ink composition, a varnish composition, and a polymer composition. For example, a product (e.g., paper product or plastic product) may include the composition, and have a brightness, defined in TAPPI Standard T452, which refers to the percentage reflectance to light of a 457 nm wavelength according to methods well known to those of ordinary skill in the art.

According to some embodiments, a composition may include an aqueous base and at least one identifying additive. The at least one identifying additive may include an alkaline earth metal compound and a fluorescence activator including at least one other inorganic element. The at least one identifying additive may be configured such that the composition emits fluorescent light having an identifying characteristic. For example, the at least one identifying additive may be configured such that the composition emits fluorescent light in the presence of ultraviolet light. The at least one other inorganic element may include at least one mixture, compound, element or alloy of manganese, molybdenum, copper, uranium, cesium, thorium, lead, cobalt, iron, strontium, calcium, magnesium, barium, tin, yttrium, thallium, samarium, cerium, thulium, and dysprosium, The alkaline earth metal compound may have a crystal structure, and the fluorescence activator may be contained in the crystal structure.

A label or packaging for identifying at least one of an object and a source of the object may include a surface associated with the label or packaging and a composition associated with the surface. According to some embodiments, the composition may include an aqueous base and at least one identifying additive. The at least one identifying additive may include an alkaline earth metal compound and a fluorescence activator including at least one other inorganic element. The at least one identifying additive may be configured such that the composition emits fluorescent light having an identifying characteristic. For example, the at least one identifying additive may be configured such that the composition emits fluorescent light in the presence of ultraviolet light. The at least one other inorganic element may include at least one mixture, compound, element or alloy of manganese, molybdenum, copper, uranium, cesium, thorium, lead, cobalt, iron, strontium, calcium, magnesium, barium, tin, yttrium, thallium, samarium, cerium, thulium, and dysprosium. The alkaline earth metal compound may have a crystal structure, and the fluorescence activator may be contained in the crystal structure.

According to some embodiments, the identifying characteristic may include at least one of a brand label, a watermark, a barcode, a quick response code, a symbol, and a label configured to display observable evidence of a physical event or thermal event. According to some embodiments, the identifying characteristic may include a predetermined emission spectrum. According to some embodiments, the at least one identifying additive may be configured such that the composition emits fluorescent light in the presence of ultraviolet light.

According to some embodiments, the identifying characteristic may be different from a characteristic of a surface against which the identifying characteristic is viewed. For example, the composition may form at least one identifying marking (e.g., such as a symbol, shape, and/or region). The identifying characteristic may be configured to facilitate identification of an object (e.g., a product) associated with the surface. According to some embodiments, the identifying characteristic may be configured to facilitate identification of a source of an object associated with the surface.

In one embodiment, there is disclosed a method for providing identifying markings on paper or packaging may include providing at least one composition in the paper or packaging, or on a surface of the paper or packaging. According to some embodiments of the method, the composition may include at least one identifying additive including an alkaline earth metal compound and a fluorescence activator including at least one other inorganic element. The at least one identifying additive may be configured such that the composition emits fluorescent light having an identifying characteristic, for example, in the presence of ultraviolet light. For example, the at least one identifying additive may be configured such that the composition emits fluorescent light having an identifying characteristic different from a characteristic of a surface against which the identifying characteristic is viewed. According to some embodiments, the fluorescence activator may include at least one mixture, compound, element or alloy of manganese, molybdenum, copper, uranium, cesium, thorium, lead, cobalt, iron, strontium, calcium, magnesium, barium, tin, yttrium, thallium, samarium, cerium, thulium, and dysprosium. According to some embodiments, the alkaline earth metal compound may have a crystal structure, and the fluorescence activator may be contained in the crystal structure.

According to some embodiments of the method, the identifying characteristic may include at least one of a predetermined wavelength and a predetermined intensity. According to some aspects, the predetermined wavelength may range from about 100 nm to about 1400 nm, such as from about 100 nm to about 750 nm, from as 100 nm to about 400 nm, from about 280 nm to about 1400 nm, 315 nm to about 1400 nm, from about 280 nm to about 750 nm.

According to some embodiments of the method, the alkaline earth metal compound may be an alkaline earth metal carbonate. For example, the alkaline earth metal carbonate may include at least one of calcium carbonate, barium carbonate, and magnesium carbonate, According to some embodiments, the alkaline earth metal carbonate may include precipitated calcium carbonate, magnesium carbonate, or a mixture of calcium and magnesium carbonates.

According to still a further aspect, the at least one identifying additive may comprise up to 10 mol % of the composition, such as less than 5 mol % of the composition, or even less than 1 mol % of the composition. According to certain embodiments, these values are noted for inorganic fluorescence activators that comprise CaCO₃, MgCO₃ or mixtures thereof.

According to some embodiments of the method, the composition may be configured as at least one of a coating composition, a paper making composition, a sizing composition, an ink composition, a varnish composition, and a polymer composition. For example, a product (e.g., paper product or plastic product) may include the composition.

The alkaline earth metal compound doped with an inorganic fluorescence activator (and the identifying additive) disclosed herein may be obtained via a number of processes. For example, the identifying additive may include an alkaline earth metal compound doped with a fluorescence activator, such as, for example, precipitated calcium carbonate doped with a fluorescence activator, such as, for example, an impurity such as manganese. Such embodiments may be formed according to the following exemplary reaction:

CaCl₂—MnCl₂+(NH₄)₂CO₃→CaCO₃:Mn.

This exemplary process provides an identifying additive including a precipitated calcium carbonate doped with impurities such as manganese, and exhibits a generally rose to orange-red luminescence when irradiated. According to some embodiments of this process, additional inorganic fluorescence activators or impurities may be included, such as, for example, lead, thallium, and cerium salt. Other fluorescence activators are contemplated, may include at least one mixture, compound, element or alloy of manganese, molybdenum, copper, uranium, cesium, thorium, lead, cobalt, iron, strontium, calcium, magnesium, barium, tin, yttrium, thallium, samarium, cerium, thulium, and dysprosium.

According to some embodiments, precipitated calcium carbonate may be obtained via another exemplary process. For example, a finely-divided phosphor grade calcium carbonate having a calcite crystalline structure and a very low sodium content may be formed from calcium chloride having a high sodium impurity content, such as, for example, 1.6% sodium chloride. The exemplary process may include forming finely-divided meta-stable vaterite on a continuous basis by continuously adding to an agitated precipitating tank aqueous solutions of calcium chloride and diammonium carbonate in such respective concentrations as to stoichiometrically produce calcium carbonate precipitate and ammonium chloride. The process may further include separating the resulting meta-stable vaterite precipitate from the mother liquor, and then resuspending the separated vaterite in an aqueous medium. Thereafter, the process may include heating the resuspended vaterite to a temperature of at least 80° C. for a sufficient period of time to cause the crystal structure of the vaterite to substantially or completely convert to calcite. The process may also include recovering the resulting calcite, which may have a sodium impurity content in the range of from about 10 parts per million (ppm) to 35 ppm. The impurities such as the fluorescence activators mentioned herein, and others, may be incorporated into the calcite crystalline structure during the reactions and/or following the reactions (e.g., in the form of a coating on the calcite crystalline structure).

According to another exemplary process, precipitated calcium carbonate may be obtained via another process that forms calcium carbonate and ammonium sulfate from gypsum obtained from flue gas desulfurization (FGD), which may be present at electric power plants. According to this exemplary process, FGD gypsum may be obtained from sulfur dioxide SO₂ gas emission control systems used at fossil fuel combustion power plants (e.g., coal-fired power plants) to remove sulfur from the combustion gases using “scrubber” devices. The sulfur dioxide may be derived from any sulfur containing compounds in the fuels. A scrubber uses lime (calcium oxide or calcium hydroxide) or more typically, limestone (calcium carbonate) to react with sulfur dioxide gas to remove the sulfur in a solid form. The scrubbing reaction uses a limestone (CaCO₃)-water slurry to produce calcium sulfite (CaSO₃) according to the following exemplary reaction:

CaCO₃(solid)+SO₂(gas)CaSO₃(solid)+CO₂(gas).

Thereafter, the CaSO₃ (calcium sulfite) may be further oxidized to produce CaSO₄.2H₂O (FGD gypsum) according to the following exemplary reaction:

CaSO₃(solid)+H₂O(liquid)+½O₂(gas)→CaSO₄(solid)+H₂O Hydration CaSO₄.½H₂O+1½H₂O→CaSO₄.2H₂O.

Thereafter, the exemplary process may further include a chemical reaction of FGD gypsum (CaSO₄.2H₂O) with ammonium carbonate ((NH₄)₂CO₃) to produce ammonium sulfate ((NH₄)₂SO₄) and calcium carbonate (CaCO₃) according to the following exemplary reaction:

(NH₄)₂CO₃+CaSO₄.2H₂O→(NH₄)₂SO₄+CaCO₃+2H₂O.

The impurities such as the fluorescence activators mentioned herein, and others, may be incorporated into the resulting precipitated calcium carbonate structure during the reactions and/or following the reactions (e.g., in the form of a coating on the calcium carbonate).

In one embodiment, a traditional process for making PCC (i.e., the lime cycle) may be used. In this process, the fluorescence activator, which may be in the form of a water soluble or water reactive salt, is added to the hydrated lime slurry obtained from the slaking process.

Other processes for forming the alkaline earth metal compound doped with an inorganic fluorescence activator or the identifying additive including alkaline earth metal compound are contemplated.

The compositions and methods according to some embodiments disclosed herein may be useful for providing labels and packaging that are not easily mimicked or copied. This may provide additional security against the distribution and marketing of products that mimic, copy, or provide counter-fit versions of name-brand products. For example, manufacturers of name-brand or luxury brand products may incorporate the compositions into packaging or labels, so that it is relatively easy to determine whether the product inside the packaging, or inside packaging including a label affixed thereto, is genuine.

The packaging or label to be protected may include markings (e.g., such as a symbol, shape, and/or region of the packaging (e.g., a region within a larger background)) that emit fluorescent light that identifies the product or source of the product as being genuine. The portion of the packaging or label including the composition may be configured to emit a fluorescent light having a certain wavelength (e.g., color) and/or intensity that is identifiable and/or verifiable, for example, in the presence of ultraviolet light. In one embodiment, the composition may be configured to emit a predetermined emission spectrum, for example, in the presence of ultraviolet light.

According to some embodiments, the portion associated with the composition may be formed as a particular symbol, shape, or region. As a result, the compositions and methods may facilitate relative ease of inspection of the packaging and/or products to determine whether they are genuine or come from the genuine source. According to other embodiments, the compositions and methods may facilitate customization of a product for a particular person or persons. Thus, such packaging and labels may be desirable for use with name-brand or luxury-brand products, such as, for example, designer fashion products and pharmaceutical products.

Other embodiments of the invention will be apparent to those skilled in the art from consideration of the specification and practice of the exemplary embodiments disclosed herein. It is intended that the specification and examples be considered as exemplary only, with a true scope and spirit of the invention being indicated by the following claims.

1. A composition comprising:
a base material comprising at least one alkaline earth metal compound doped with an inorganic fluorescence activator,
wherein the composition emits a fluorescent response when irradiated, and
wherein the composition is configured as at least one of a coating composition, a paper making composition, a sizing composition, an ink composition, a varnish composition, and a polymer composition.

2. The composition of claim 1, wherein the base material comprises a resin, a fusible powder, an aqueous composition, or a solvent composition.

3. The composition of claim 1, wherein the alkaline earth metal compound comprises an alkaline earth metal salt.

4. The composition of claim 3, wherein the alkaline earth metal salt is an alkaline earth metal carbonate.

5. The composition of claim 4, wherein the alkaline earth metal carbonate comprises at least one of calcium carbonate, barium carbonate, and magnesium carbonate.

6. The composition of claim 5, wherein said calcium carbonate comprises precipitated calcium carbonate.

7. The composition of claim 4, wherein the alkaline earth compound comprises a mixture of calcium and magnesium carbonates.

8. The composition of claim 7, wherein said mixture comprises co-precipitated calcium and magnesium carbonates.

9. The composition of claim 1, wherein the alkaline earth metal compound has a crystal structure, and wherein the inorganic fluorescence activator is contained in the crystal structure.

10. The composition of claim 1, wherein the inorganic fluorescence activator comprises at least one mixture, compound, element or alloy of manganese, molybdenum, copper, uranium, cesium, thorium, lead, cobalt, iron, strontium, calcium, magnesium, barium, tin, yttrium, thallium, samarium, cerium, thulium, and dysprosium.

11. The composition of claim 1, wherein the fluorescent response comprises a predetermined fluorescent signature configured to be used as an identifying characteristic chosen from a brand label, a watermark, a barcode, a quick response code, a symbol, and a label configured to display observable evidence of a physical event or thermal event.

12. The composition of claim 1, wherein the predetermined fluorescent signature comprises at least one emission spectrum configured to emit the fluorescent response when irradiated at a predetermined wavelength.

13. The composition of claim 12, comprising a mixture of distinct alkaline earth metal carbonates, each of which exhibit a distinguishable fluorescent signature when exposed to the same excitation source.

14. The composition of claim 13, wherein the distinguishable fluorescent signature comprises a difference in intensity of the emission spectrum resulting from a difference in the ratios of the alkaline earth metal carbonates.

15. The composition of claim 1, wherein the inorganic fluorescence activator is configured such that the composition emits fluorescent light in the presence of ultraviolet light.

16. The composition of claim 1, wherein the inorganic fluorescence activator comprises up to 10 mol % of the composition.

17. The composition of claim 1, wherein the inorganic fluorescence activator comprises less than 5 mol % of the composition.

18. A product comprising the composition of claim 1.

19-31. (canceled)

32. A label or packaging for identifying at least one of an object and a source of the object, the label or packaging comprising:
a surface associated with the label or packaging; and
the composition of claim 1.

33-49. (canceled)

50. A method for providing identifying markings on paper or packaging, the method comprising:
providing at least one composition in the paper or packaging, or on a surface of the paper or packaging,
wherein the composition comprises a base material comprising at least one alkaline earth metal compound doped with an inorganic fluorescence activator,
wherein the composition emits a fluorescent response when irradiated.
